(19) United States
(12) Patent Application Publication
(10) Pub. No.: US 2010/0219369 A1
(43) Pub. Date: Sep. 2, 2010

(54) COMPOSITION OF THERMAL INTERFACE MATERIAL

(75) Inventors: Kuo-Chan Chiou, Tainan City (TW); Lu-Shih Liao, Taichung City (TW); Tzong-Ming Lee, Hsinchu City (TW)

Correspondence Address: J C PATENTS, 4 VENTURE, SUITE 250, IRVINE, CA, 92618, US

(73) Assignee: INDUSTRIAL TECHNOLOGY RESEARCH INSTITUTE, Hsinchu (TW)

(21) Appl. No.: 12/778,665

(22) Filed: May 12, 2010

Related U.S. Application Data
(63) Continuation-in-part of application No. 11/430,700, filed on May 8, 2006.

(30) Foreign Application Priority Data
Dec. 20, 2005 (TW) 94145217

(51) Int. Cl. C09K 5/00

(52) U.S. Cl. 252/74

(57) ABSTRACT

A composition of a thermal interface material is provided. The deficiencies of low thermal conductivity and high thermal resistance in the conventional thermal interface materials are resolved. By using carbon fibers with high thermal conductivity, the thermal conductivity of the thermal interface material can be about 7˜10 times higher than the traditional thermal interface materials. The added amount of carbon fibers is less than the added amount of metal or ceramic powders. The dispersion process is thereby improved. Further, the thermal interface material has a phase change temperature at about 40˜65° C. Holes, gaps and dents on the surface of device are filled at the normal operation temperature of device to reduce the thermal resistance of the entire device and to increase the interfacial bonding strength.

### CROSS-REFERENCE TO RELATED APPLICATION

This application is a continuation-in-part of and claims the priority benefit of U.S. application Ser. No. 11/430,700, filed on May 8, 2006, now pending, which claims the priority benefit of Taiwan application Ser. No. 94145217, filed on Dec. 20, 2005. The entirety of each of the above-mentioned patent applications is hereby incorporated by reference herein and made a part of this specification.

### BACKGROUND OF THE INVENTION

1. Field of the Invention

The present invention relates to a thermal management material for electronic devices. More particularly, the present invention relates to a composition of a thermal interface material.

2. Description of Related Art

As electronic products are being rapidly introduced to the market, not only these electronic products are desired to be light, thin, compact and small, they are required to be highly functional and to have high transmission speed and operation efficiency. Under operation, the various devices, such as a CPU, generate a great amount of heat, and the temperature of the devices increases correspondingly. As a result, the devices may become defective. Accordingly, the thermal dissipation capability of the product or the devices needs to be improved to maintain the efficiency thereof.

To dissipate the waste heat, a heat sink is normally disposed on the device, the discrete power or the logic integrated circuits. Accordingly, thermal interface materials play an important role in thermal management. To enhance the thermal communication between the device and the heat sink, thermal interface materials with the appropriate thermal conductivity and thermal resistance must be identified.

A typical thermal interface material is normally composed of a silicon resin, an aliphatic polymer, a low molecular polyester, an acrylic resin, wax or an epoxy type of phase change resin material. Metal or ceramic powders, such as aluminum nitride (AlN), boron nitride (BN), aluminum oxide (Al₂O₃), zinc oxide (ZnO) and artificial diamond are further added as the thermal conductive material.

In order for the thermal interface material to have the phase change characteristics, the base resin normally has lower molecular weight and low melting point. However, this type of resin easily degrades under a repeated operation of the device, and the thermal stability of the resin becomes poor. Consequently, the contact area diminishes and the efficiency of thermal dissipation is greatly reduced.

Although metal or ceramic powders serving as the thermal conductive material have an acceptable thermal conductivity, the thermal conductivity is significantly reduced after the thermal conductive material is incorporated with the base resin to form the thermal interface material. To increase the thermal conductivity of the thermal interface material, a large quantity of the metal or ceramic powders must be added (about 50 to 90 wt %). However, the increase of the amount of the thermal conductive material increases the interface thermal resistance, and the thermal dissipation efficiency of the entire packaged device is lower eventually. Consequently, the cost is increased. Accordingly, the conventional thermal interface material has a low thermal conductivity and a high thermal resistance.

### SUMMARY OF THE INVENTION

The present invention provides a composition of a thermal interface material that has a high thermal conductivity.

The present invention also provides a composition of a thermal interface material, which can be applied to a heat sink of an electronic product used in computers, communication products and consumer electronics, and in the various industries, such as automobile, medical, aerospace and communication.

The present invention provides a composition of a thermal interface material, wherein the composition includes a thermoplastic resin and carbon fibers. The percentage of the phase change thermoplastic resin in the thermal interface material is about 65-99 by weight and the percentage of the carbon fibers is about 1 to 35 by weight.

In the above-mentioned thermal interface material composition, the melting point of the phase change thermoplastic resin is lower than 100° C. The thermoplastic resin includes, but not limited to, ethylene vinyl acetate, ethylene-vinyl acetate copolymer, polyvinyl chloride (PVC), rosin ester, polypropylene random copolymer, polyoxymethylene copolymer, polyolefin, polyamide, polycarbonate, polyester, ethylene vinyl acetate, polyvinyl acetate, polyimide, or a mixture thereof

In the above-mentioned thermal interface material composition, the thermoplastic resin includes ethylene-vinyl acetate copolymer. The melt index of the ethylene-vinyl acetate copolymer is about 2 to 100 g/10 min. The amount of vinyl acetate in the ethylene-vinyl acetate copolymer is about 30 to 50 weight percent.

In the above-mentioned thermal interface material composition, the average diameter of the carbon fiber is about 50 to 300 nm, and the length/diameter (aspect) ratio of the carbon fiber is about 10 to 2000.

The above thermal interface material composition further includes a solvent, such as toluene, xylene, or methyl ethyl ketone.

In the above thermal interface material composition, the percentage of the thermoplastic resin in the composition is about 70 to 99 by weight, while the percentage of the carbon fibers is about 1 to 30 by weight.

In the above thermal interface material composition of the present invention, the carbon fibers with a high thermal conductivity is used to lower the added amount of the thermal conductive material. Not only the thermal conductivity of the thermal interface material can be easily increased, the dispersion process can be improved to prevent an aggregation of the carbon fibers, which may adversely affect the thermal conductivity and the mechanical properties.

The thermal conductivity of the thermal interface material composition prepared with carbon fibers is about one to two times of the thermal conductivity of the thermal interface materials in the prior art. Moreover, the added amount of the carbon fibers is far less than that of the traditional metal or ceramic powders. Therefore, the dispersion process can be improved.

The phase change temperature of the thermal interface material of the present invention is about 40 to 65° C. Therefore, under a normal operating temperature, the thermal interface material can fills the holes, cracks and voids on the device's surface to effectively lower the thermal resistance of the entire device. As a result, the deficiencies of a low thermal conductivity and a high thermal resistance in the current thermal interface materials can be improved. Further, with the thermal interface material of the present invention, the interfacial bonding can be enhanced.

Several exemplary embodiments of the invention will now be described in detail with reference to the accompanying drawings. It is to be understood that the foregoing general description and the following detailed description of preferred purposes, features, and merits are exemplary and explanatory towards the principles of the invention only and are not restrictive of the invention, as claimed.

### BRIEF DESCRIPTION OF THE DRAWINGS

FIG. 1 shows the temperature-dependent variations of the dynamic viscosities of Elvax®205W, Elvax®210ET and Elvax®40W used in the Embodiments and the Comparative Examples of this application.

### DESCRIPTION OF THE PREFERRED EMBODIMENTS

Reference will now be made in detail to the present preferred embodiments of the invention. It is to be understood that both the foregoing general description and the following detailed description are exemplary, and are intended to provide further explanation of the invention as claimed.

The thermal interface material composition of the present invention primarily includes a thermoplastic resin and carbon fibers as the thermal conductive material.

In the present invention, the phase change materials are a class of materials that exists in a solid state, a semisolid glassy state or a crystalline state at normal room temperature, for example, 25° C. These materials undergo a transition to a liquid state, a semi-liquid state or a viscous fluid state at a high temperature or in high ambient temperature. The phase transition temperature of the phase change thermoplastic resin is preferably fall within the operating temperatures of the device, for example, between 40 to 75° C. Moreover, the melting point of the phase change thermoplastic resin is preferably lower than 100° C., more preferably lower than 70° C.

The phase change thermoplastic resin of the present invention includes, but not limited to, ethylene vinyl acetate, ethylene-vinyl acetate copolymer, polyvinyl chloride, rosin ester, polyoxymethylene copolymers, polyolefin, polyamide, polycarbonate, polyester, ethylene vinyl acetate, polyvinylacetate, polyimide or a mixture thereof

The average diameter of the carbon fibers that serves as the thermal conductive material is about 50 to 300 nm. Moreover, the length/diameter ratio of the carbon fibers is about 10 to 2000.

The thermal interface material composition of the present invention further includes a solvent, such as toluene, xylene or methyl ethyl ketone. The thermal interface material composition of the present invention may also include common additives such as a lubricant or a surfactant, a pacifying agent or an anti-foaming agent, a chain extender, a tackifier, a pigment, a stabilizer, a flame retardant and an antioxidant.

In the thermal interface material composition of the present invention, the percentage of the phase change thermoplastic resin in the composition is about 65 to 99 by weight, and is preferably about 70 to 99 by weight. The percentage of the carbon fibers is about 1 to 35 by weight, and is preferably about 1 to 30 by weight.

The following embodiments and comparative examples are used to illustrate the effects of the thermal interface material composition of the present invention. It is to be understood that these embodiments are presented by way of example and not by way of limitation. In the following embodiments and comparative examples, the phase change thermoplastic resin is selected to be ethylene-vinyl acetate (EVA) copolymer, in which the melt index is about 60 to 800 g/10 min. The amount of vinyl acetate in the ethylene-vinyl acetate copolymer is about 25 to 45 weight percent. The carbon fibers are manufactured by Showa Denko. The diameter of the carbon fibers is about 150 nm. Aluminum oxide is manufactured by Showa Denko. The diameter of aluminum oxide is about 1.4 micron. The melting point of the EVA copolymer is about 50-80° C.

### Embodiment 1

A one-liter, four-mouth glass reactor with a three-impeller stirrer is provided. About 600 g of a toluene solvent is added into the glass reactor. About 200 g of the phase change thermoplastic resin, the ethylene-vinyl acetate copolymer (Elvax®40W, DuPont), is further added and stirred to dissolve. About 20 g of the carbon fibers (VGCF, d-150 nm, Showa Denko Co.) is slowly added to the phase change thermoplastic resin solution while being stirred. After an even mixing at high speed for about 30 minutes, a thermal interface material with a high thermal conductivity is resulted.

### Embodiment 2

A one-liter, four-mouth glass reactor with a three-impeller stirrer is provided. About 600 g of a toluene solvent is added into the glass reactor. About 200 g of the phase change thermoplastic resin, the ethylene-vinyl acetate copolymer (Elvax®40W, DuPont), is further added and stirred to dissolve. About 40 g of the carbon fibers (VGCF, d-150 nm, Showa Denko Co.) is slowly added to the phase change thermoplastic resin solution while being stirred. After an even mixing at high speed for about 30 minutes, a thermal interface material with a high thermal conductivity is resulted.

### Embodiment 3

A one-liter, four mouth glass reactor with a three-impeller stirrer is provided. About 600 g of a toluene solvent is added into the glass reactor. About 200 g of the phase change then ioplastic resin, the ethylene vinyl acetate copolymer (Elvax®40W, DuPont), is further added and stirred to dissolve. About 40 g of the carbon fibers (VGCF, d-150 nm, Showa Denko Co.) is slowly added to the phase change thermoplastic resin solution while being stirred. After an even mixing at high speed for about 30 minutes, the solution is subjected to a dispersion process for three times using a triple roller to obtain a thermal interface material with a high thermal conductivity.

### Comparative Example 1

A one-liter, four-mouth glass reactor with a three-impeller stirrer is provided. About 600 g of a toluene solvent is added into the glass reactor. About 200 g of the phase change thermoplastic resin, the ethylene vinyl acetate copolymer (Elvax®40W, DuPont), is further added and stirred to dissolve. An even mixing at high speed is then conducted for about 30 minutes to obtain a thermal interface material.

### Comparative Example 2

A one-liter, four-mouth glass reactor with a three-impeller stirrer is provided. About 600 g of a toluene solvent is added into the glass reactor. About 200 g of the phase change thermoplastic resin, the ethylene vinyl acetate copolymer (Elvax®40W, DuPont), is further added and stirred to dissolve. Under stirring, about 40 g of aluminum oxide (Al₂O₃, d=1.4 μm, Showa Denko Co.) is slowly added. An even mixing at high speed is then conducted for about 30 minutes to obtain a thermal interface material.

### Comparative Example 3

A one-liter, four mouth glass reactor with a three-impeller stirrer is provided. About 600 g of a toluene solvent is added into the glass reactor. About 200 g of the phase change thermoplastic resin, the ethylene vinyl acetate copolymer (Elvax®40W, DuPont), is further added and stirred to dissolve. Under stirring, about 40 g of aluminum oxide (Al₂O₃, d=1.4 μm, Showa Denko Co.) is slowly added. After an even mixing at high speed for about 30 minutes, the solution is subjected to a dispersion process for three times using a triple roller to obtain a thermal interface material.

After the preparations for the thermal interface material compositions of embodiments 1 to 3 and comparative examples 1 to 3 are completed, physical analyses of these compositions are conducted. The physical analyses include the determinations of the thermal conductivity and the phase change temperature using differential scanning calorimetry (DSC). The compositions from Embodiment 1 to 3 and comparative examples 1 to 3 and the corresponding physical properties are summarized in Table 1.

TABLE 1

| | Ethylene- vinyl | | | | Phase Change | Thermal |
|---|---|---|---|---|---|---|
| | acetate | Carbon | Aluminum | | Temperature | Conductivity, |
| | copolymer | Fiber | Oxide | Toluene | (DSC, ° C.) | K (W/m*° C.) |
| Embodiment 1 | 200 | 20 | — | 600 | 40~65 | 2.3 |
| Embodiment 2 | 200 | 40 | — | 600 | 42~65 | 3.5 |
| Embodiment 3 | 200 | 40 | — | 600 | 42~65 | 5.8 |
| Comparative eg 1 | 200 | — | — | 600 | 45~78 | 0.13 |
| Comparative eg 2 | 200 | — | 40 | 600 | 38~75 | 0.45 |
| Comparative eg 3 | 200 | — | 40 | 600 | 38~75 | 0.49 |

According on the results summarized in Table 1, the thermal interface material compositions of Embodiments 1 to 3 have higher thermal conductivity than those of Comparative examples 1 to 3. In other words, the results suggest that carbon fibers can be used as a thermal conductive material to raise the thermal conductivity of the thermal interface material. Accordingly, it is more desirable to apply carbon fibers as the thermal conductive material than the conventional metal or ceramic powders.

Moreover, with the same amount of ingredients, the thermal conductivity of the thermal interface material composition of Embodiment 2 is about 7 to 8 times of the thermal conductivity of the thermal interface material composition of Comparative Example 2. In other words, the amount of carbon fibers needs to be added is far less than the amount of metal or ceramic powders. As a result, the dispersion process is improved.

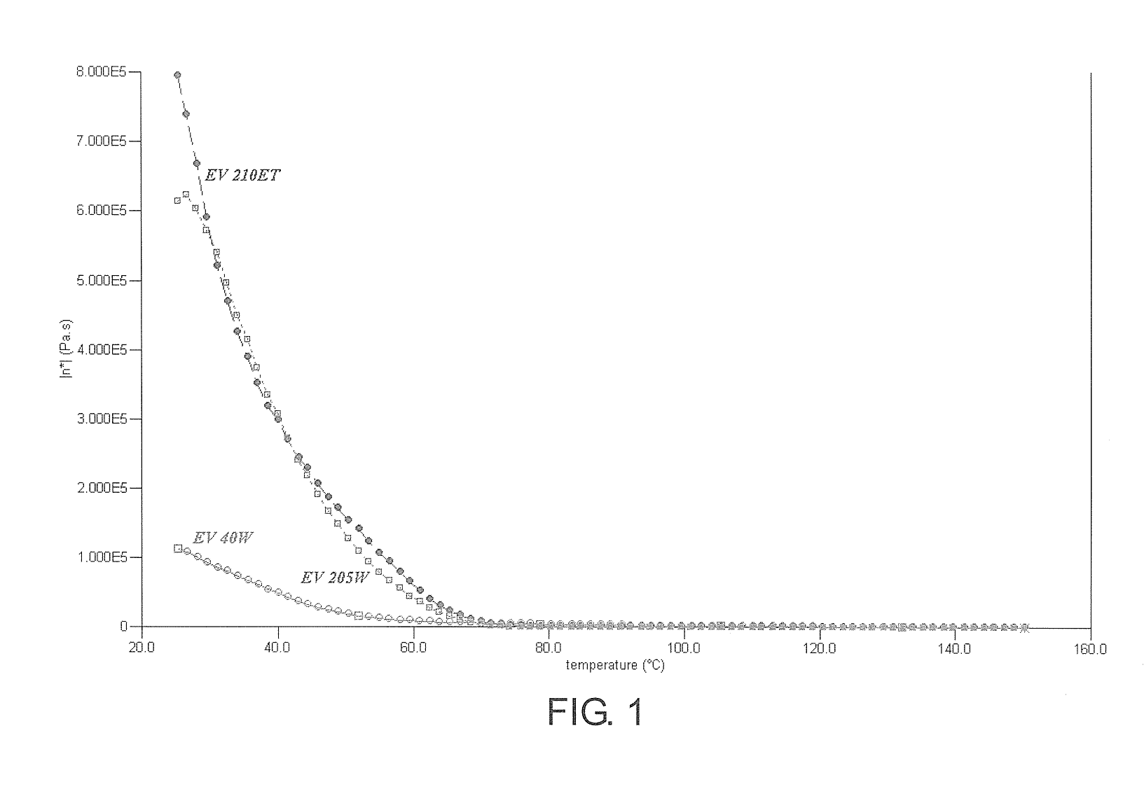

More embodiments and comparative examples are described below, wherein two other EVA copolymers from DuPont, Elvax®205W and Elvax®210ET, were used. Some physical properties of Elvax®205W, Elvax®210ET and Elvax®40W used in Embodiments 1-3 and Comparative Examples 1-3 are listed in Table 2. The variations of the dynamic viscosities of Elvax®205W, Elvax®210ET and Elvax®40W with the temperature are shown in FIG. 1.

TABLE 2

| | Elvax ® 40W | Elvax ® 205W | Elvax ® 210ET |
|---|---|---|---|
| MFR (g/10 min) | 52 | 800 | 400 |
| Vinyl acetate | 40 | 28 | 28 |
| content (wt %) | | | |
| Density (kg/m³) | 965 | 951 | 951 |
| Melting Point (° C.) | 47 | 72 | 82 |

### Comparative Example 4

A one-liter, four-mouth glass reactor with a three-impeller stirrer was provided. About 600 g of toluene was added into the glass reactor. About 200 g of Elvax®205W was further added and stirred to dissolve. Under stirring, about 40 g of the carbon fibers (VGCF, d=150 nm, Showa Denko Co.) was slowly added. After an even mixing at high speed for about 30 minutes, the solution was subjected to a dispersion process for three times using a triple roller to obtain a thermal interface material.

### Comparative Example 5

A one-liter, four-mouth glass reactor with a three-impeller stirrer was provided. About 600 g of toluene was added into the glass reactor. About 200 g of Elvax®205W was further added and stirred to dissolve. After an even mixing at high speed was then conducted for about 30 minutes to obtain a thermal interface material.

### Comparative Example 6

A one-liter, four-mouth glass reactor with a three-impeller stirrer was provided. About 600 g of toluene was added into the glass reactor. About 200 g of Elvax®205W was further added and stirred to dissolve. Under stirring, about 40 g of aluminum oxide (Al₂O₃, d=1.4 μm, Showa Denko Co.) was slowly added. After an even mixing at high speed for about 30 minutes, the solution was subjected to a dispersion process for three times using a triple roller to obtain a thermal interface material.

### Comparative Example 7

A one-liter, four-mouth glass reactor with a three-impeller stirrer was provided. About 600 g of toluene was added into the glass reactor. About 200 g of Elvax®210ET was further added and stirred to dissolve. Under stirring, about 40 g of carbon fibers (VGCF, d=150 nm, Showa Denko Co.) was slowly added. After an even mixing at high speed for about 30 minutes, the solution was subjected to a dispersion process for three times using a triple roller to obtain a thermal interface material.

### Comparative Example 8

A one-liter, four-mouth glass reactor with a three-impeller stirrer was provided. About 600 g of toluene was added into the glass reactor. About 200 g of Elvax®210ET was further added and stirred to dissolve. After an even mixing at high speed was then conducted for about 30 minutes to obtain a thermal interface material.

### Comparative Example 9

A one-liter, four-mouth glass reactor with a three-impeller stirrer was provided. About 600 g of toluene was added into the glass reactor. About 200 g of Elvax®210ET was further added and stirred to dissolve. Under stirring, about 40 g of aluminum oxide (Al₂O₃, d=1.4 μm, Showa Denko Co.) was slowly added. After an even mixing at high speed for about 30 minutes, the solution is subjected to a dispersion process for three times using a triple roller to obtain a thermal interface material.

The thermal interface material compositions of Comparative Examples 4-9 were subjected to the same physical analyses mentioned above. The compositions and their physical properties are summarized in Table 3.

TABLE 3

| | Ethylene-vinyl | | | | | | |
|---|---|---|---|---|---|---|---|
| | acetate copolymer | | | | | Melting Point | K |
| | 205W | 210ET | VGCF | Al₂O₃ | Toluene | (DSC, ° C.) | (W/m*° C.) |
| Comparative eg 4 | 200 | — | 40 | — | 600 | 63-88 | 2.11 |
| Comparative eg 5 | 200 | — | — | — | 600 | 60-87 | 0.11 |
| Comparative eg 6 | 200 | — | — | 40 | 600 | 60-88 | 0.48 |
| Comparative eg 7 | — | 200 | 40 | — | 600 | 70-97 | 1.89 |
| Comparative eg 8 | — | 200 | — | — | 600 | 67-95 | 0.11 |
| Comparative eg 9 | — | 200 | — | 40 | 600 | 67-95 | 0.46 |

According to Table 2, FIG. 1 and the results of Embodiment 3 and Comparative Examples 4 and 7 that are different only in the type of EVA copolymer, the following facts were known. Though Elvax®205W and Elvax®210ET have larger melt flow indexes (MFR) than Elvax®40W, they adversely have dynamic viscosities about 6-8 times larger than that of Elvax®40W in low temperature (<65° C.) operations according to the measurements of their rheological behaviors shown in FIG. 1. Therefore, Elvax®205W and Elvax®210ET have lower wetting effects than Elvax®40W and are difficult to lower the thermal resistance at the interface.

The higher dynamic viscosities of Elvax®205W and Elvax®210ET at low temperatures are due to their higher melting points (72° C. and 82° C.). Accordingly, the EVA copolymer as the phase change thermoplastic resin in a thermal interface material preferably has a melting point lower than 70° C. In addition, the vinyl acetate content in the EVA copolymer is preferably 30-50 wt %, according to Table 2 and the results of Embodiment 3 and Comparative Examples 4 and 7.

In addition, after being subjected to the dispersion process with the triple roller, the thermal conductivity of the thermal interface material is further improved.

Accordingly, the thermal interface material composition that includes carbon fibers with high thermal conductivity can lower the amount of the thermal conductive material needs to be added. The aggregation of the carbon fibers can be prevented to avoid lowering the thermal conductivity and adversely affecting the mechanical property of the material.

The thermal conductivity of the thermal interface material composition prepared with carbon fibers is about 7 to 10 times higher than that with the traditional metal or ceramic powders. Moreover, the amount of carbon fibers added is far less than the amount of metal or ceramic powders. Accordingly, the dispersion process can be enhanced.

Moreover, the phase change temperature of the thermal interface material of the present invention is at about 40 to 65° C. Therefore, under the normal operating temperatures of the device, voids, cracks and holes on the surface of the device can be filled to lower the thermal resistance. Accordingly, the deficiencies of a low thermal conductivity and a high thermal resistance in the existing thermal interface materials can be improved. Furthermore, the interfacial bonding strength can also be increased.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A composition of a thermal conductive material comprising:
a phase change thermoplastic resin, wherein a percentage of the phase change thermoplastic resin in the composition is about 65 to 99 by weight; and
carbon fibers, wherein a percentage of the carbon fibers in the composition is about 1 to 35 by weight,
wherein a melting point of the phase change thermoplastic resin is lower than 70° C.

2. The composition of claim 1, wherein the phase change thermoplastic resin is selected from the group consisting of ethylene vinyl acetate, ethylene-vinyl acetate copolymer, polyvinyl chloride, rosin ester, polyoxymethylene copolymers, polyolefin, polyamide, polycarbonate, polyester, ethylene vinyl acetate, polyvinylacetate, polyimide and a mixture thereof.

3. The composition of claim 1, wherein the phase change thermoplastic resin is an ethylene-vinyl acetate copolymer.

4. The composition of claim 3, wherein a melt index of the ethylene-vinyl acetate copolymer is about 2 to 100 g/10 min.

5. The composition of claim 3, wherein a percentage of vinyl acetate in the ethylene-vinyl acetate copolymer is 30-50 wt %.

6. The composition of claim 1, wherein an average diameter of the carbon fibers is about 50 to 300 nm.

7. The composition of claim 1, wherein a length/diameter ratio of the carbon fibers is about 10 to 2000.

8. The composition of claim 1 further comprising a solvent.

9. The composition of claim 8, wherein the solvent is toluene, xylene or methyl ethyl ketone.

10. The composition of claim 1, wherein the percentage of the phase change thermoplastic resin is about 70 to 99 by weight and the percentage of the carbon fibers is about 1 to 30 by weight.
